(19) United States
(12) Patent Application Publication
(10) Pub. No.: US 2008/0000671 A1
(43) Pub. Date: Jan. 3, 2008

(54) Cable bundle clamp with two opposing spring-loaded hinged shells

(76) Inventor: Christopher Randall Bratt, Twin Falls, ID (US)

Correspondence Address: Owen L. Lamb, PO Box 386, Prescott, AZ, 86302-0386, US

(21) Appl. No.: 11/480,733

(22) Filed: Jul. 3, 2006

(51) Int. Cl. H01B 7/00

(52) U.S. Cl. 174/135

(57) ABSTRACT

A cable-bundle clamp that provides a clamp and tie-down for cable bundles. The clamp includes two opposing hinged shells forming a hexagonal shape when the shell halves are closed. The shell halves are spring-loaded, biased in an open configuration. When closed the two halves are held closed by a latch. Alternatively the shell halves are spring-loaded biased in a closed configuration. The two halves are held opened manually for insertion of the cable. When closed, the two halves are held closed by the spring.

### BACKGROUND OF THE INVENTION

1. Field of the Invention

The invention relates generally to the field of cable management systems including clamps, ties and other devices that are used to bundle electrical and optical cables, and more specifically, to a cable bundle clamp for packaging cables in bundles.

2. Description of the Prior Art

Within the consumer home electronics industry, there is a need for an effective cable management system; a system that simplifies the wide array of wires and cables that exist in almost every home and office in the United States and Canada. What is needed is an effective economical and simple way of organizing cables for computers, stereo, home theater systems and other types of cables. Whether the cables are exposed and the user desires to organize cables for aesthetic reasons, or the cables are hidden from view and the user desires to categorize the cables for ease of identification.

There is also a need to provide a cable bundle tie that accommodates varying bundle sizes. One purpose of the invention is to provide a new and improved cable bundle clamp.

### SUMMARY OF THE INVENTION

Briefly, the invention is concerned with a clamp for securing a cable bundle. A first half circle shaped shell element and a second half circle shaped shell element are joined by an elastic device at a proximate side of the first half circle shaped shell element and a proximate side of the second half circle shaped shell element to provide a hinge. The elastic device may be a spring biased so as to hold the first half circle shaped shell element and the second half circle shaped shell element in an opened position or in a closed position.

In accordance with an aspect of the invention, the spring is biased so as to hold the shell elements in an opened position. A first fastener is provided on a distal side of the first half circle shaped shell element and a second fastener is provided on a distal side of the second half circle shaped shell element. The first fastener and the second fastener are constructed so as to mate one with the other to secure the first and second half circle shaped shell elements together in opposition to force of the spring.

In accordance with a further aspect of the invention, the spring is biased so as to hold the shell elements in a closed position. A first handle is provided on a proximate side of the first half circle shaped shell element and a second handle is provided on a proximate side of the second half circle shaped shell element. The first handle and the second handle are constructed so as to oppose one another to urge the first and second half circle shaped shell elements apart in opposition to force of the spring upon manual exertion of force on the first and second handles.

In accordance with a further aspect of the invention, the elastic device may be an integral molded part of the first and second half circle shaped shell elements or may a separate flat spring or a coil spring.

In accordance with a further aspect of the invention, the elastic device is a spring. In this case, the first half circle shaped shell element includes a recess on a proximate side of the first half circle shaped shell element receiving and securing one end of the spring. The second half circle shaped shell element has a recess on a proximate side of the second half circle shaped shell element receiving and securing an opposite end of the spring.

In either embodiment, some of the outer surfaces of the clamp may be flat, such as to form a polygonal shape to facilitate the attachment of the clamp to a flat surface by two-sided adhesive tape, a rivet, staple, nail or screw.

The invention is next described further in connection with preferred embodiments, and it will become apparent that various additions, subtractions, and modifications can be made by those skilled in the art without departing from the scope of the invention.

### BRIEF DESCRIPTION OF THE EMBODIMENTS

A more complete understanding of the invention may be obtained by reference to the drawings, in which:

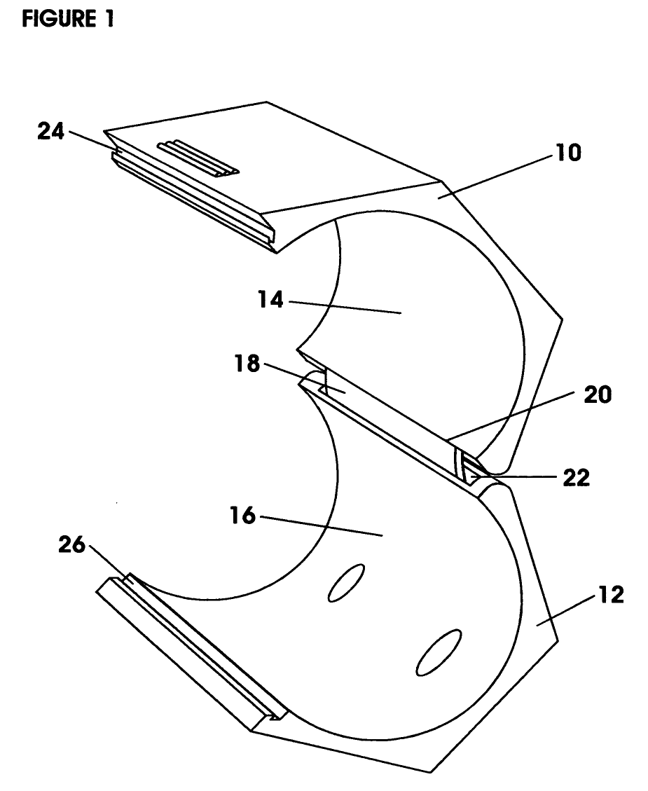

FIG. 1 is a perspective view of a cable bundle clamp constructed according to a first embodiment of the invention, shown in the spring-biased open position;

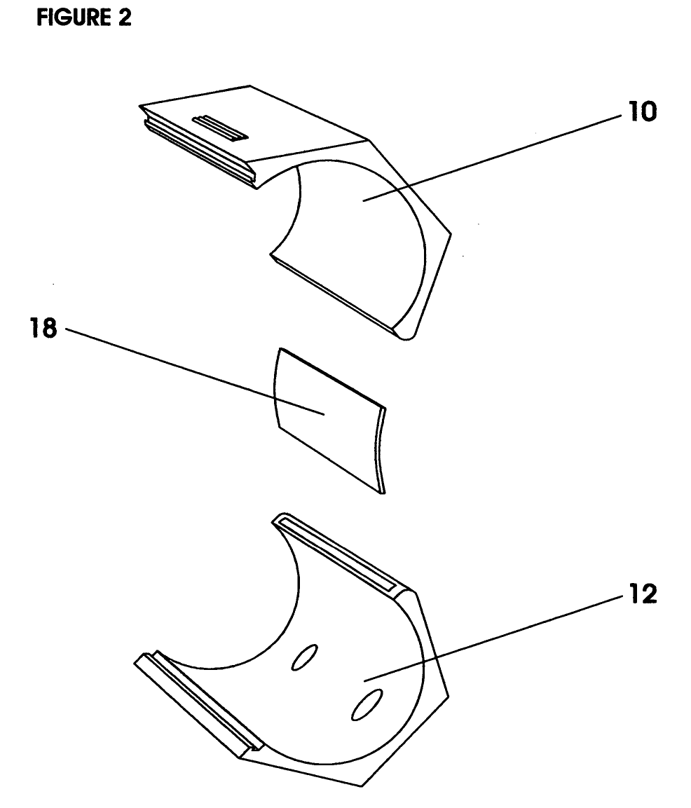

FIG. 2 is an exploded perspective view of the cable bundle clamp shown in FIG. 1;

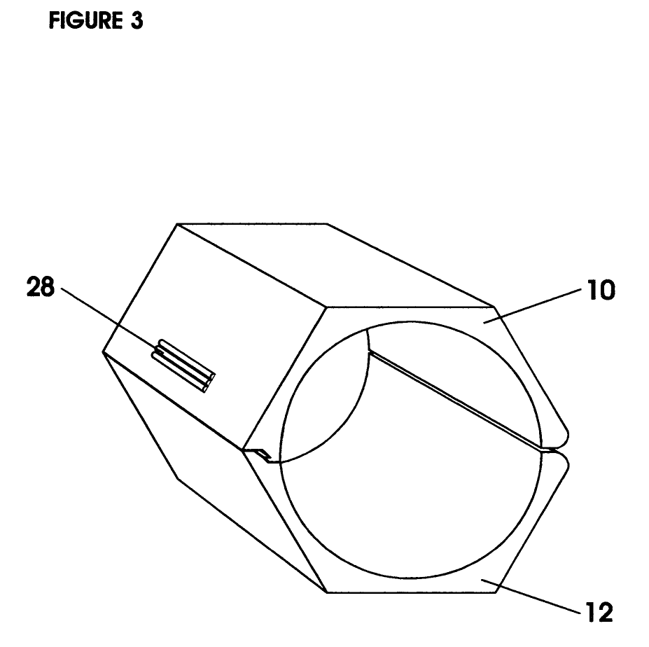

FIG. 3 is a perspective view of the cable bundle clamp of FIG. 1 locked in the closed position, in accordance with the invention;

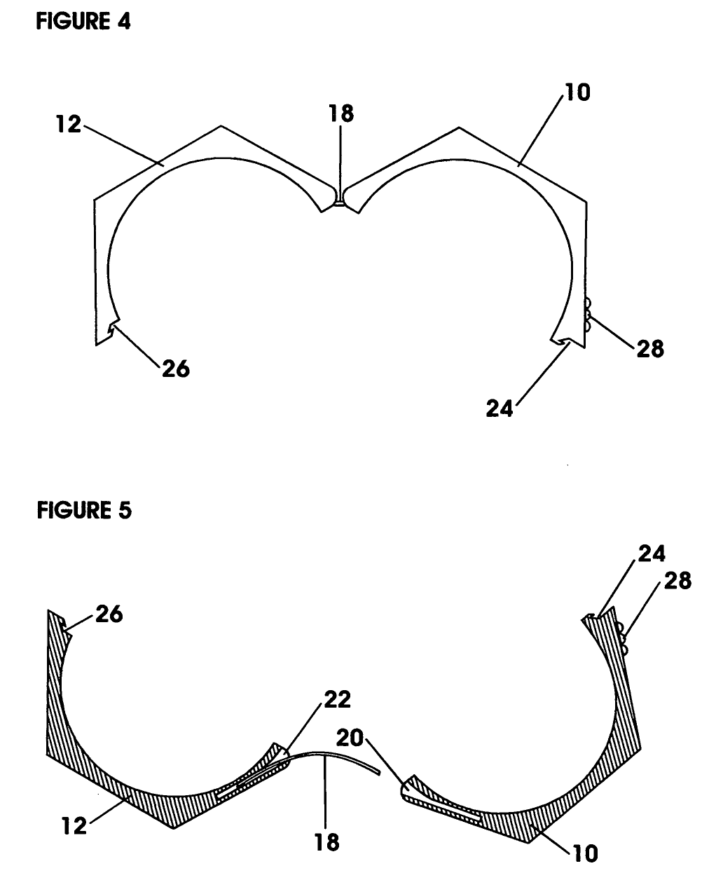

FIG. 4 is a side elevation view of the opened cable bundle clamp of FIG. 1;

FIG. 5 is an exploded cross-sectional view of the cable bundle clamp of FIG. 1;

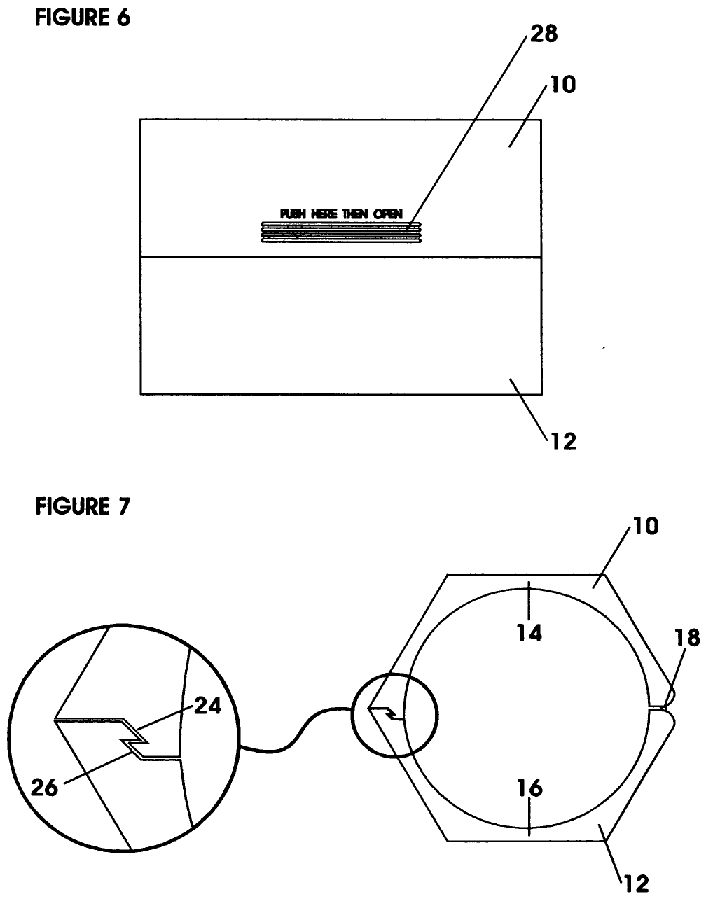

FIG. 6 is a front view of the clamp of FIG. 1;

FIG. 7 is a side elevation view of the closed cable bundle clamp of FIG. 1;

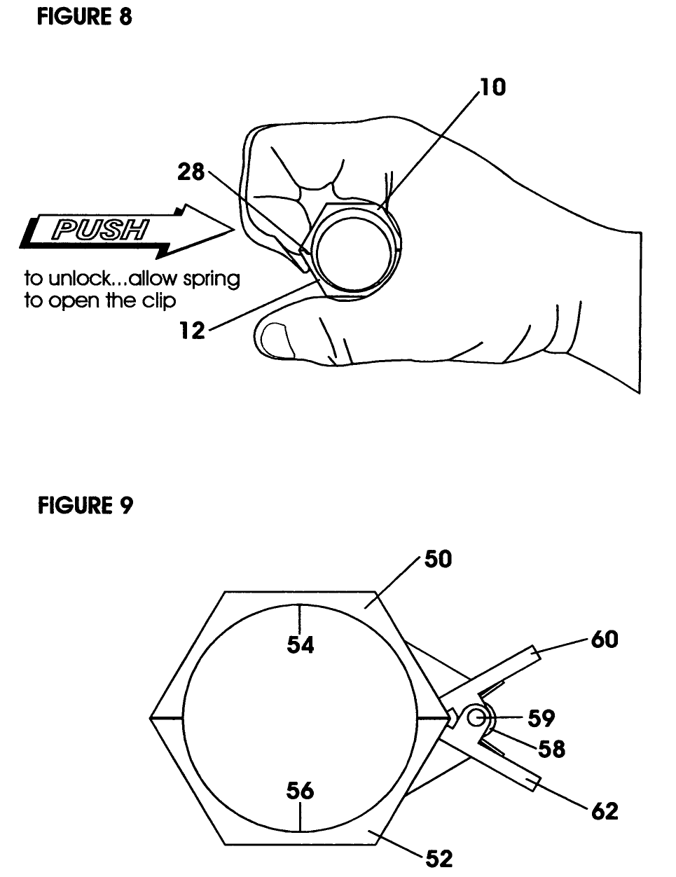

FIG. 8 is an illustration of manually opening the closed cable bundle clamp of FIG. 2;

FIG. 9 is a side elevation view of a cable bundle clamp constructed according to a second embodiment of the invention, shown in the spring-biased closed position;

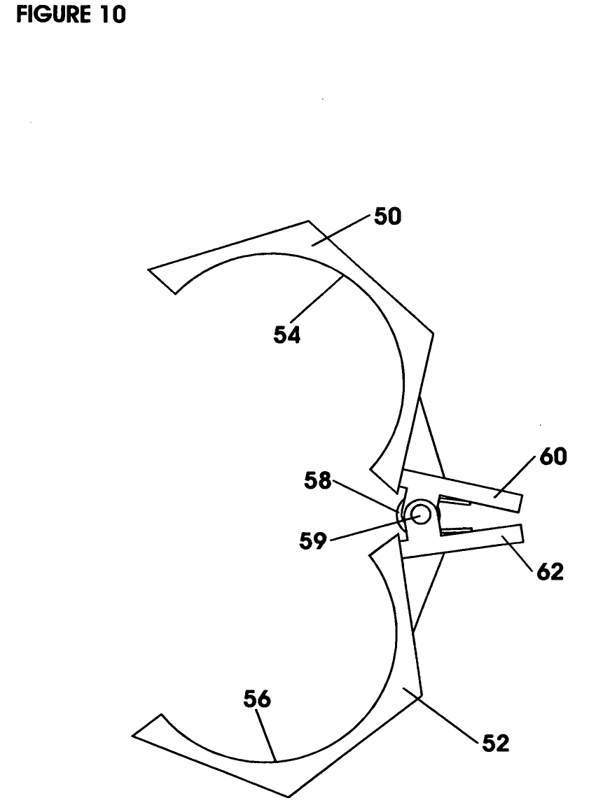

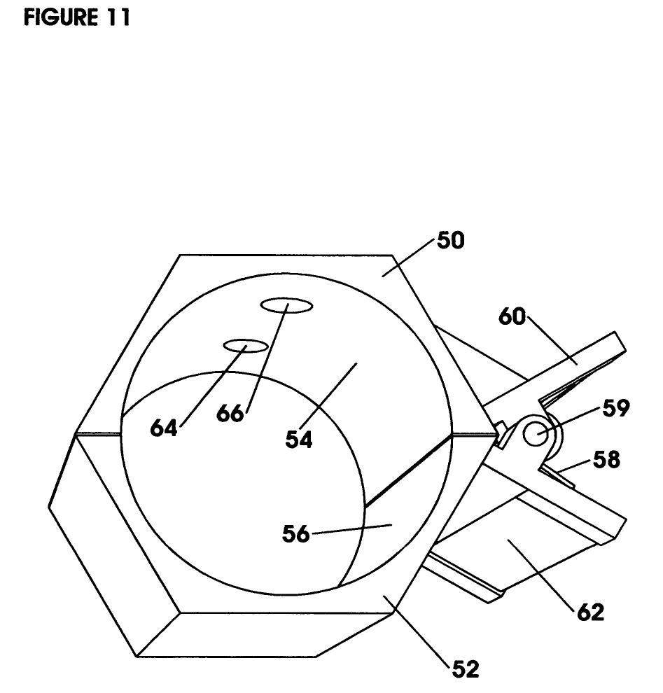

FIG. 10 is a side elevation view of the cable bundle clamp of FIG. 9, shown in the manually opened position;

FIG. 11 is a perspective view of cable bundle of FIG. 9 spring-loaded in the closed position, in accordance with the invention.

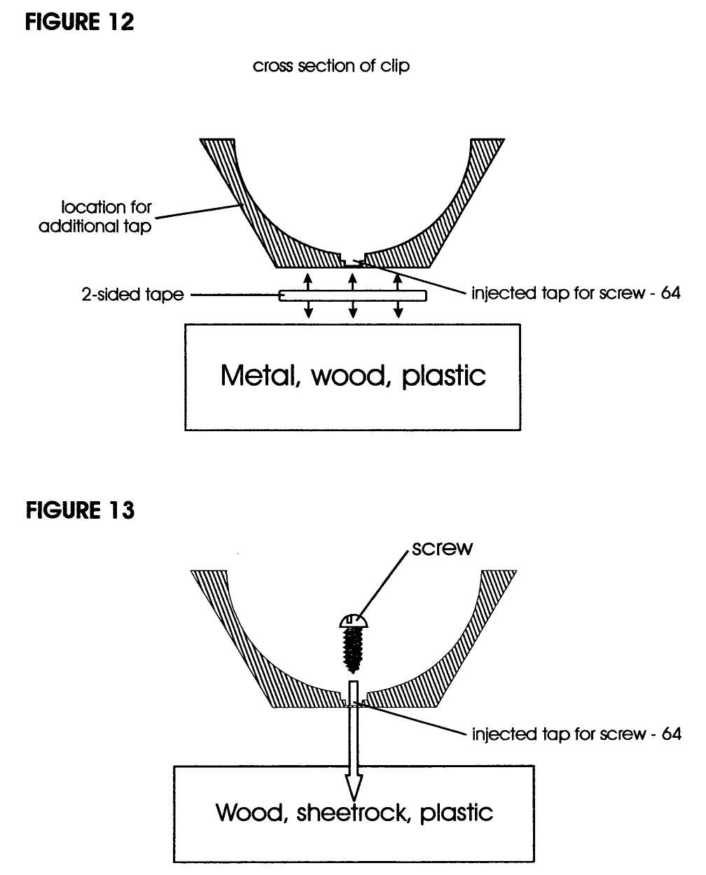

FIG. 12 is a cross-sectional view of an opened cable bundle clamp 2-sided tape attachment method;

FIG. 13 is a cross-sectional view of an opened cable-bundle clamp, tap-screw attachment method;

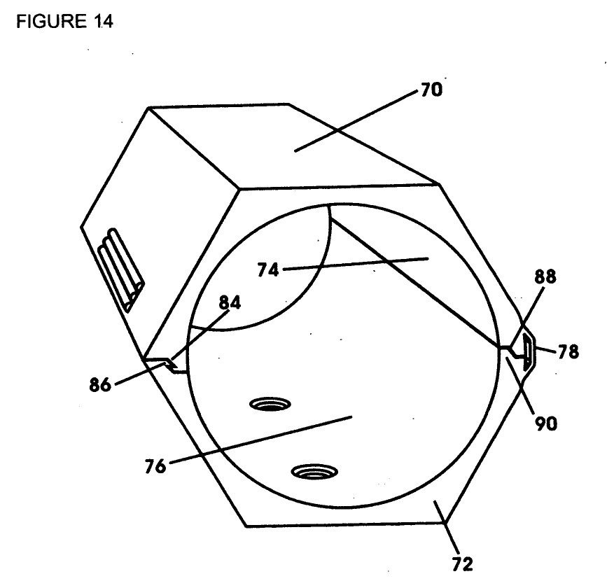

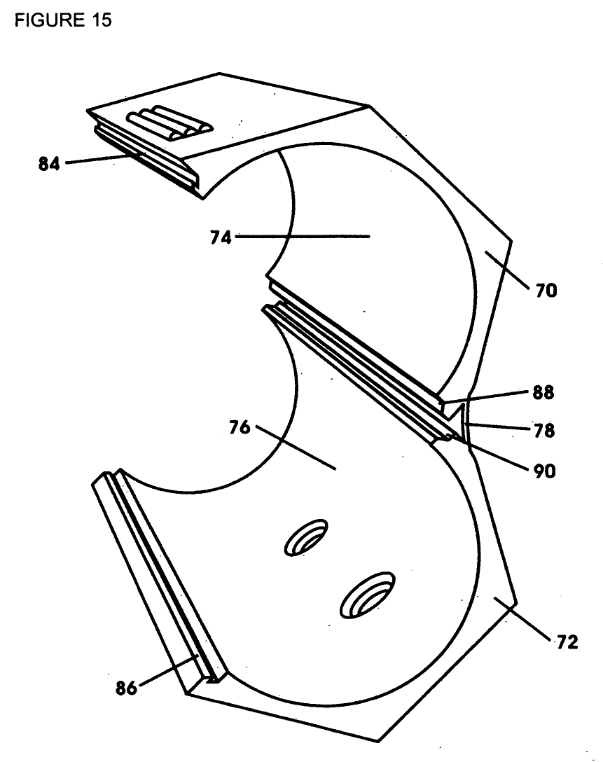

FIG. 14 is a perspective inside view of a cable bundle clamp constructed according to a third embodiment of the invention, shown in the closed position;

FIG. 15 is a perspective inside view of cable bundle of FIG. 14 shown in the spring-biased opened position;

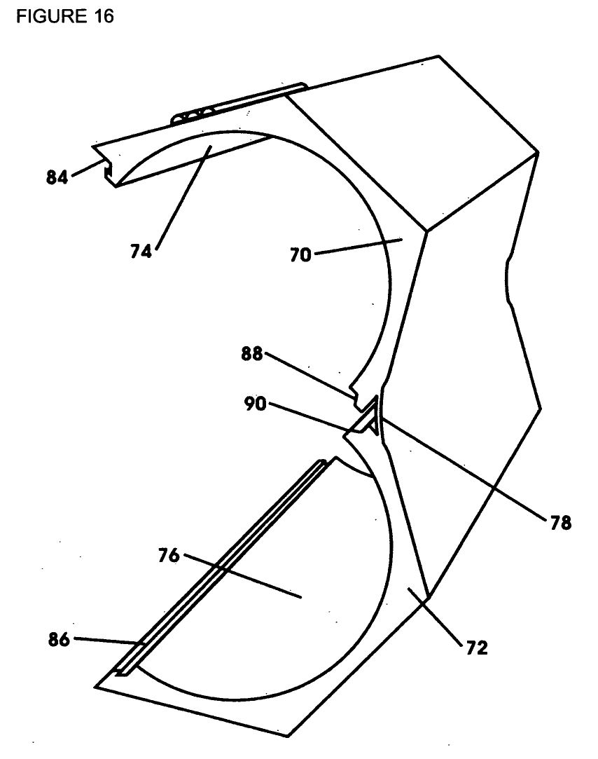

FIG. 16 is a perspective outside view of cable bundle of FIG. 14 shown in the spring-biased opened position; and,

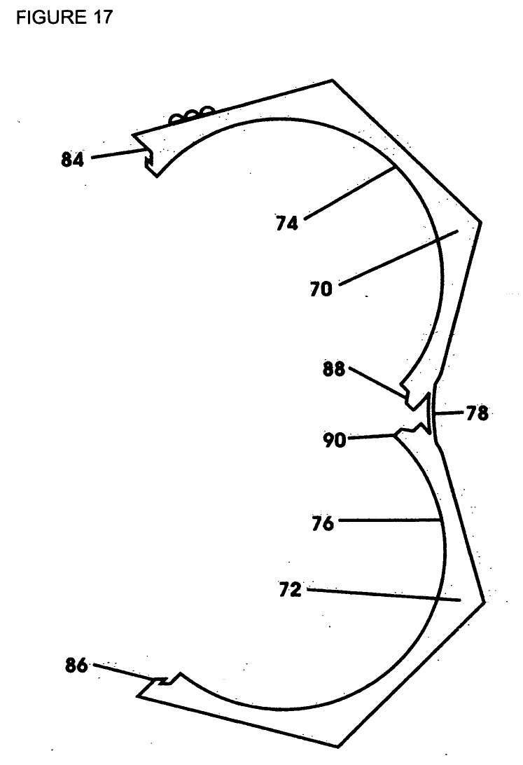

FIG. 17 is a side elevation view of the cable bundle clamp of FIG. 14 shown in the spring-biased opened position;

### DETAILED DESCRIPTION OF THE INVENTION

### First Embodiment of the Invention

Refer to FIGS. 1 and 2, which are perspective views of a cable bundle clamp constructed in accordance with a first embodiment of the invention, shown in the spring-biased open position. The clamp is comprised of two half shells, 10, 12 each having an inner cavity 14, 16, respectively. The shells 10, 12 are held open by a metal spring 18 that is biased in the open position and inserted in grooves 20, 22 cut or molded at a proximate end of each shell. The other distal end of a shell 10 has a notch 24 cut or molded in the end that is shaped to engage a mating notch 26 in the other shell 12.

Refer to FIG. 3, which is a perspective view of cable bundle of FIG. 1 held in the closed position, in accordance with the invention. When pressed closed, the two notches 24, 26 engage each other and latch the shell halves.

Refer to FIG. 4, which is a cross-sectional view of the opened cable bundle clamp of FIG. 1. The spring 18 is biased to hold the two halves of the clamp in the opened position.

Refer to FIG. 5, which is an exploded cross-sectional of the cable bundle clamp of FIG. 1. The spring 18 is press fitted into the grooves 20, 22, in each of the shell halves.

Refer to FIG. 6, which is a front view of the clamp of FIG. 1. The clamp has several ridges forming traction bars 28 molded onto the surface of at least one shell half with the instructions “PUSH HERE THEN OPEN” (or words to that effect) printed near the ridges.

Refer to FIG. 7, which is a cross-sectional view of the closed cable bundle clamp of FIG. 1. The enlarged part of the figure shows the shape of the notches 24, 26, which are shaped so that one shell half mates in a locking relationship with the other shell half.

Refer to FIG. 8, which is an illustration of manually opening the closed cable bundle clamp of FIG. 2. The fingers press against the traction bars to unlock the two halves allowing the spring 18 to force the halves apart.

### Second Embodiment of the Invention

Refer to FIG. 9, which is a perspective view of a cable bundle clamp constructed in accordance with a second embodiment of the invention, shown in the spring-biased closed position. The clamp is comprised of two half shells, 50, 52 each having an inner cavity 54, 56, respectively. The shells 50, 52 are held closed by a metal spring 58 that is biased in the closed position. The shells 50, 52 are opened manually by pressing against handle grips 60, 62, which are attached or molded at an end of each shell.

The two half-cylindrical shaped elements 50, 54, are connected to form an open circle held open by a spring 58, which is held in place by pin 59. The outside of each element has three flat sides, or six total to form a hexagon on the exterior of the clamp. On one side, each half cylinder has a protruding plate handle. The handles 60, 62, are constructed so as to leverage the shell elements 50, 54, apart in opposition to force of the spring 58 upon manual exertion of force on the handles. When assembled, these handles are manually pressed together to open the opposite side of the clamp similar to a jaw opening up. When open, one bundles the wires together, inserts the bundle in the mouth of the clamp and releases the handles. The jaws of the clamp close and clamp down under spring pressure touching each other to encase the wires in a neat, organized fashion.

Refer to FIG. 10, which is a side elevation view of cable bundle of FIG. 9 held in the opened position by manually exerted force on handles 60, 62, against spring tension 58, in accordance with the invention.

Refer to FIG. 11, which is a perspective view of cable bundle clamp of FIG. 9 held in the closed position by spring-exerted force, in accordance with the invention. In this figure two injected taps, 64 and 66 for fastening screws are illustrated.

In both embodiments of the invention, the flat outer sides of the clamp allow a user to identify the contents of the bundle of wires by placing decals or by using indelible ink on one or more of the flat surfaces. The flat surfaces of the clamp provide an attachment surface to mate with any flat surface using screws or two-sided tape. The flat surfaces may also serve as an area for logo placement in the event a retailer would like a trademark logo on the clamp, either with decals or die cast.

Furthermore, for industrial applications the clamp may be cast in various colors to further aid in cable recognition. Initial product packaging for consumer applications includes large, medium and small clamps. This allows for numerous wiring configurations and takes into account the elimination of wires from a bundle due to directions they must run. This also eliminates all the clutter and disorganized wires behind computers, home theatre systems and other similar electronic devices.

Refer to FIG. 12, which is a cross-sectional view of an opened cable bundle clamp 2-sided tape attachment method.

Refer to FIG. 13, which is a cross-sectional view of an opened cable-bundle tap-screw attachment method.

Method of Manufacture

For the first embodiment, the clamp is formed in two molds, an upper mold and a lower mold. The back, proximate or hinge side of the clamp has a molded recessed area into which a pre-bent or spring biased piece of steel is inserted. When inserted in the lower half of the clamp, the metal spring bows away from the radius of the inside of the clamp. When the spring is inserted into the upper half of the clamp, the clamp is held open. The front side of the clamp is the closing side of the clamp, opposite the hinge. The upper and lower sections of the clamp are molded with interlocking latching sections. When pressed together, the latches overlap and with the pressure of the spring urging the clamp open, and remain closed until the upper section of the clamp is pushed inward manually. This allows the interlocking upper and lower sections of the clamp to clear each other allowing the clamp to open by force of the spring.

The spring is held in place by the natural bend in it that creates the spring. The radius of the spring is slightly greater than that of the section into which it is inserted, thus keeping contact to retain it in place.

This design includes many desirable usability features: flat exterior sides, cylindrical interior, 2 tapped areas per upper and lower section (covered on the outside), molded in colors, and available in different sizes for various applications.

The first embodiment of the invention clamp illustrated in FIGS. 1-8 is comprised of three separate molded pieces.

Piece #1. Piece one, the top half of the clamp as viewed from the end, is a molded plastic piece. The piece roughly takes the shape of the letter “C”. Piece one has a cylindrical interior, or half circle (180 degrees), while the outside consists of three equal flat sections with a combined radius of 180 degrees. This piece is molded in several colors to help the end user identify the contents in the clamp. Furthermore, clear plastics may be used in the event of rope lighting or chemical lines.

Piece #2. Piece two is a piece of metal, cut to a particular length and height, that fits into pieces one and three by means of a slot in each respective piece. Piece two has a curvature to it, to allow the assembled pieces to be held in the open position under spring pressure.

Piece #3. Piece three, the lower half of the clamp as viewed from the end, is a molded plastic piece. The piece roughly takes the shape of the letter “C”. Piece three has a cylindrical interior, or half circle (180 degrees), while the outside consists of three equal flat sections with a combined radius of 180 degrees. This piece is molded in several colors to help the end user identify the contents in the clamp. Furthermore, clear plastics may be used in the event of rope lighting or chemical lines.

The invention also includes engineered features as follows:

EXTERIOR. Flat surfaces allow a user to write on the exterior of the clamp to identify its contents and/or to attach one clamp to another clamp or some other relatively flat surface through the means of pre-cut two-sided adhesive tape. Sticking several clamps together allows the user to control a larger bundle of wires. Furthermore, one could route wires to a desired location, or follow a path setout by a manufacturer. Such a path may be located on the back of an entertainment center, the underside of a desk, the back of a filing cabinet etc. The end user can peel and apply this tape as needed for the clamp to adhere to a clean flat surface. This same area can be used for the application of a retailing user's logo and applied at the time of manufacturing. This can be done through either a special injection mold with the user's logo or through the application of a decal with the user's logo printed thereon. Another feature of the flat surface is the permanent application of the clamp to a hard surface. This can be achieved by screwing the clamp to the to the surface by two wood or metal tapping screws. For this purpose each upper and lower section of the clamp includes a pre-tapped section. This section, as viewed from an opened clamp, has two predetermined and engineered round sections, evenly spaced and recessed slightly from the inside surface of the clamp. Midway through this round section, the diameter of the hole is narrowed to allow an area for the head of a screw to come to rest. This firmly holds the clamp in place without the possibility of the screw going all the way through the plastic or the weight of the contents of the clamp breaking the clamp. Furthermore, this recessed area allows the head of the screw to sink to the level of the interior diameter of the opening to allow full usage of the opening. It will also minimize the possibility of damaging wires with the metal edges of the screw. The exterior of the clamp has a thin membrane of molded plastic covering the tapped area so when viewed from the exterior, the holes do not appear. Obviously, if a user's logo is to be used in this area, the use of the screws becomes ineffective. However, the use of a decal will still allow the use of a permanent application.

ENDS. The ends of pieces one and three are flat in orientation.

INTERIOR. The interior of the clamp is cylindrical with no rough edges to damage or fray the contents therein. Each half comprises 180 degrees of the assembled 360-degree clamp. Injected text that tells the user what size screw is recommended for permanent application can be included on the interior of the clamp. If the contents have an exterior diameter smaller than that of the interior diameter of the clamp, the contents are contained, but not held firmly in place. An example of this an item oriented vertically. If a clamp is placed on a bundle having a smaller exterior diameter than the inner diameter of the clamp, the clamp could slide along the bundle to a point lower than the users desired location. In this situation, a small piece of foam can be used to wrap the bundle to increase the exterior diameter, thus making contact with the clamp and keeping it in its desired location.

SLOT. Pieces one and three include a slot on the back half of each piece. This slot traverses into each respective piece. The slot is curved in nature to follow the curvature of the interior surface. Piece two fits into each of these slots.

SLOT SIDE CURVE. The slot side of the clamp is designed with a curved edge. This curved edge allows pieces one and three to open wide without making contact.

SCREW TAPS. Pieces one and three each include two sections located on the interior of the piece to be used to attach the clamp to any surface by means of two screws. This area is molded with an open section on the interior of the section and a thin layer of plastic or “flashing” covering the exterior of the piece. When viewed from a “cut-a-way” side view, this section has a “step down” section used to seat the screw and lower the overall height of the head of the screw to that of the inside diameter of the clamp's radius. This minimizes the possibility of a metal screw fraying the contents of the clamp and allows the maximum usage of the interior of the clamp. The flashing on the outside of the clamp is a thin membrane of plastic that covers the holes from the outside, thus keeping the top and bottom flat sections aesthetically pleasing to the eye. This flashing is thin enough to allow any screw to easily penetrate the flashing without damaging pieces one and three beyond the edges of the tap.

UPPER-LOCKING SECTION. (FIG. 7) Pieces one and three include locking sections on the opposing side of the slot that receives the metal spring. This locking section runs the full length of the piece and is comprised of a section (when viewed from the end) that has an angular configuration. When the sections 24, 26, from each clamp come into contact, when pushed together, force each clamp away from the other. Once the end of angular configuration is reached, the pieces lock as the tension of the molded plastic push the piece 24 into piece 26. To open, the user need only push on the locking section 24, enough to clear the angular locking configuration, at which point the opening spring pulls the upper and lower sections apart and forces the clamp open.

OPENING SPRING. The opening spring 18 is a piece of pre-bent steel used to open and keep closed pieces one and three. This piece slides into the slot (FIG. 5) of both pieces. Once the opening spring has been installed its natural tendency to pull the locking sections away from one another, to hold the clamp open. This aids the user with one-handed application and aids in the ease of permanent application of the clamp through use of the screw taps. Furthermore, it also keeps the clamp closed as it puts tension on the locking section pushing them together.

LOWER LOCKING SECTION. This part is the reverse of the locking section listed above.

TRACTION BARS. This area 28 of FIG. 3 is designed with a series of raised bars molded to section one. The traction bars are used to aid the user in opening the clamp while under pressure from the opening spring. The traction bars are located below the area used for identification of the contents of the bundle.

The clamp may be molded in different colors. This adds an additional level of identification in industrial applications. A user may want to run all lines in a call center through a particular area. They may desire phone lines be run through a black clamp while LAN, Intranet, internet or fiber optic lines would be routed through red, green, blue or yellow.

The second embodiment of the invention clamp illustrated in FIGS. 9-11 is comprised of three separate molded pieces as in the first embodiment. The difference is that the spring 58 is biased to hold the sections closed. The half-shell sections are molded with handles 60, 62, that provide leverage for opening the clamp. The half-shell sections are molded with holes to accommodate a hinge pin 59 which is inserted through the holes and the coil spring 58.

The third embodiment of the invention clamp illustrated in FIGS. 14-17 is comprised of one separate molded piece, similar in features to the first embodiment. The difference is that the spring is an integral part of the molded piece and is biased to hold the sections open.

### Third Embodiment of the Invention

Refer to FIGS. 14, 15, 16 and 17, which are views of a cable bundle clamp constructed in accordance with a third embodiment of the invention. The clamp is comprised of two half shells, 70, 72 each having an inner cavity 74, 76, respectively. The shells 70, 72 are held open by a molded plastic “living hinge” spring 78 that is biased in the open position. The half shell and spring are molded as one piece. The other distal end of a shell 70 has a notch 84 cut or molded in the end that is shaped to engage a mating notch 86 in the other shell 72. The exterior corners are rounded to aid in the flow of resin in the mold. The radii 88, 90, are rounded to minimize pinching of cable wires placed inside the clamp. The portions 88 and 90 will come in contact with each other just prior to the notches 84, 86, engaging. This feature will provide tension needed to keep the clamp securely closed.

There is an offset section 88, 90, that upon closing of the clamp comes into contact prior to the locking side 84, 86, of the clamp. This offset design of the hinging side provides a means to align the two pieces 70, 72, so the locking section 84, 86, engages seamlessly.

Refer to FIG. 14, which is a perspective view of cable bundle held in the closed position, in accordance with the invention. When pressed closed, the two notches 84, 86 engage each other and latch the shell halves.

Refer to FIGS. 15 and 16, which are perspective views of the opened cable bundle clamp of FIG. 14. The spring 78 is biased to hold the two halves of the clamp in the opened position. The clamp has several ridges molded onto the surface of at least one shell half with the instructions “PUSH HERE THEN OPEN” (or words to that effect) printed near the ridges, as shown in FIG. 6.

The shape of the notches, 84, 86, are such that one shell half mates in a locking relationship with the other shell half.

FIG. 17 is a side view of the opened cable bundle clamp of FIG. 14.

Epilogue

What has been described is a clamp for securing a cable bundle. A first half circle shaped shell element and a second half circle shaped shell element are joined by an elastic device at a proximate side of the first half circle shaped shell element and a proximate side of the second half circle shaped shell element to provide a hinge. The elastic device may be a spring biased so as to hold the first half circle shaped shell element and the second half circle shaped shell element in an opened position or in a closed position.

In a first embodiment (FIGS. 1-8), the elastic device is a spring 18 biased so as to hold the first half circle shaped shell element 10 and the a second half circle shaped shell element 12 in an opened position. A first fastener 24 is provided on a distal side of the first half circle shaped shell element and, a second fastener 26 is provided on a distal side of the second half circle shaped shell element. The first fastener and the second fastener are constructed so as to mate one with the other to secure the first and second half circle shaped shell elements together in opposition to force of the spring 18.

In a second embodiment (FIGS. 9-11), the elastic device is a spring 58 biased so as to hold the first half circle shaped shell element 50 and the a second half circle shaped shell element 52 in a closed position. A first handle 60 is provided on a proximate side of the first half circle shaped shell element 50 and a second handle 62 is provided on a proximate side of the second half circle shaped shell element 52. The first handle and the second handle are constructed so as to oppose one another to urge the first and second half circle shaped shell elements apart in opposition to force of the spring upon manual exertion of force on the first and second handles.

In a third embodiment (FIGS. 14-17), the elastic device is an integral part of the first and second half circle shaped shell elements, by molding the clamp in a single mold.

The elastic device may be a flat spring as in FIG. 1, a coil spring as in FIG. 9 or a “living hinge” as in FIG. 14.

If the elastic device is a flat spring as in FIG. 1, the first half circle shaped shell element includes a recess 20 on a proximate side of the first half circle shaped shell element for receiving and securing the spring 18. The second half circle shaped shell element also has a recess 22 on a proximate side of the second half circle shaped shell element receiving and securing the spring 18.

In any embodiment, some of the outer surfaces of the clamp may be flat, such as to form a polygonal shape. The polygonal shape is a closed figure bounded by three or more surfaces, to facilitate the attachment of the clamp to a flat surface by two-sided adhesive tape or a rivet, staple, nail or screw (see FIGS. 12 and 13).

Those skilled in the art will realize that the clamp is designed to contain, house, hold, route, restrict, vector, direct, and organize any product capable of fitting within its interior space. This includes, but is not limited to, items of any size with a description of the following: electrical lines, phone lines, fiber optic lines, chemical lines, water lines, cable lighting, power cords, speaker wire, and game controllers.

The invention has been described in respect of a clamp having a fixed size interior diameter. Those skilled in the art will realize that if the contents have an exterior diameter smaller than that of the interior diameter of the clamp, the contents may not be held firmly in place. To make the interior conform to the size of the contents, a small piece of foam may be used to wrap the bundle to increase the exterior diameter of the bundle, thus ensuring contact with the interior contour of the clamp. Alternatively, the notch cut or molded in the end of one half shell that is shaped to engage a mating notch in the other shell can be replaced with a notched strap on one shell that engages mating notches in a slot the other shell to provide a variable interior diameter.

Those skilled in the art will also realize that the design of the clamp considers usable features for all applications interior and exterior. The flexibility of use allows for several applications. They include, but are not limited to, applications such as: home and business computers, industrial and home theater and stereo systems, home and commercial gaming systems (Nintendo, X-Box and Playstation), extension cords, power and/or control cords for appliances, phone cords, automotive wiring, automotive stereos and video applications, aviation wiring, maritime applications (wiring), rope lighting, Christmas lighting (interior and exterior), and medical equipment

While the invention has been described in respect of a metal spring, those skilled in the art will understand that any elastic device may be employed. By way of example, a plastic hinge molded integral with the two half shells, a flat spring, a coil of wire, or other device that regains its original shape after being compressed or extended.

1. A one-piece molded cable-bundle clamp comprising:
two opposing hinged shells forming a polygonal exterior shape and a circular interior shape of a given diameter;
said shell halves being joined together by an integral molded part between said two opposing hinged shells and biased in an open configuration creating an opening greater than said given diameter;
a first fastener on a distal side of a first one of said two opposing hinged shells; and
a second fastener on a distal side of a second one of said two opposing hinged shells;
said first fastener and said second fastener being constructed so as to mate one with the other to secure said opposing hinged shells together.

2-12. (canceled)

13. A one-piece molded clamp for securing a cable comprising:
a first half circle shaped shell element; and
a second half circle shaped shell element;
said first and second elements being joined together by an integral molded part at a proximate side of said first half circle shaped shell element and a proximate side of said second half circle shaped shell element;
said first and second elements being biased in an open configuration by said integral molded part creating an opening greater than the diameter of said half circle.

14. (canceled)

15. The clamp of claim 13 further comprising:
a first fastener on a distal side of the first half circle shaped shell element and a second fastener on a distal side of the second half circle shaped shell element;
said first fastener and said second fastener being constructed so as to mate one with the other to secure said first and second half circle shaped shell elements together in opposition to force of said integral molded part.

16. (canceled)

17. (canceled)

18. (canceled)

19. (canceled)

20. (canceled)

21. The cable bundle clamp of claim 1 wherein:
said first fastener is a first notch and said second fastener is a second notch;
said first and second notches being such that the two notches engage each other to latch said two half shells closed upon a condition that said shells are forced to a closed position.
